(19) United States
(12) Patent Application Publication
(10) Pub. No.: US 2024/0284145 A1
(43) Pub. Date: Aug. 22, 2024

(54) TRACKER AND TRACKING METHOD THEREOF AND CLUSTERED TRACKING SYSTEM AND TRACKING METHOD THEREOF

(71) Applicant: Wistron NeWeb Corporation, Hsinchu (TW)

(72) Inventors: Ying-Hung LO, Hsinchu (TW); Tzu-Yang HUANG, Hsinchu (TW)

(21) Appl. No.: 18/428,181

(22) Filed: Jan. 31, 2024

(30) Foreign Application Priority Data
Feb. 17, 2023 (TW) 112105867

(51) Int. Cl. H04W 4/029

(52) U.S. Cl. CPC H04W 4/029

(57) ABSTRACT

A clustered tracking system includes a plurality of trackers and a cloud server. Each of trackers includes a remote communication circuit, a positioning circuit and a processing circuit. The positioning circuit obtains a position information. The cloud server respectively receives a plurality of identity information and a plurality of position information from a plurality of the remote communication circuits, and classifies the trackers being adjacent to each other into a tracked cluster according to the identity information and the position information, and transmits a cluster command to the tracked cluster. The trackers in the tracked cluster are divided into a first tracker and at least one second tracker. The first tracker enters a working state in a working time period according to the cluster command. The second tracker enters a sleep state according to the cluster command.

### RELATED APPLICATIONS

This application claims priority to Taiwan Application Serial Number 112105867, filed Feb. 17, 2023, which is herein incorporated by reference.

### BACKGROUND

### Technical Field

The present disclosure relates to a wireless communication technology field. More particularly, the present disclosure relates to a tracker and a tracking method thereof, and a clustered tracking system and a tracking method thereof.

### Description of Related Art

In recent years, trackers can be applied for tracking items or goods. Trackers are not only used to track the trajectories of goods in long-distance transportation, but also to prevent goods from being lost during the transportation. The tracker is composed of multiple modules, such as modem, Bluetooth-Low-Energy (BLE) module, Global Positioning System (GPS) module, Micro Control Unit (MCU) and battery.

With the advancement of semiconductor technology, it is now possible to reduce the size of the abovementioned modules of the tracker, and extend the running time of the tracker through a large-capacity battery. However, there is a trade-off relationship between the capacity and volume of the battery. Therefore, to reduce the size of the tracker, it is necessary to use a battery with a smaller capacity, but it will shorten the running time of the tracker with the smaller capacity. In view of this, the market lacks a tracker that can maintain a long running time and has a small size, and thus this is an issue to be resolved by the related industry.

### SUMMARY

According to one aspect of the present disclosure, a tracker includes a positioning circuit, a remote communication circuit and a processing circuit. The positioning circuit is configured to obtain a position information. The remote communication circuit is configured to be signally connected to a cloud server. The processing circuit is connected to the positioning circuit and the remote communication circuit, and operates in a default mode. In the default mode, the processing circuit controls the remote communication circuit to transmit an identity information and the position information to the cloud server. The remote communication circuit receives a cluster command from the cloud server, so that the processing circuit is changed from the default mode to a cluster mode according to the cluster command, and the cluster command includes one of a work command and a rest command, and a working time period. In the cluster mode, the processing circuit controls the tracker to enter a working state in the working time period according to the work command; the processing circuit controls the tracker to enter a sleep state according to the rest command.

According to another aspect of the present disclosure, a tracker tracking method includes performing an information collecting step, an information transmitting step and a mode changing step. The information collecting step includes configuring a processing circuit of a tracker to operate in a default mode. In the default mode, the processing circuit collects a position information from a positioning circuit of the tracker. The information transmitting step includes configuring the processing circuit to control a remote communication circuit of the tracker to transmit an identity information and the position information to a cloud server. The mode changing step includes configuring the remote communication circuit to receive a cluster command from the cloud server, so that the processing circuit is changed from the default mode to a cluster mode according to the cluster command, and the cluster command includes one of a work command and a rest command, and a working time period. In the cluster mode, the processing circuit controls the tracker to enter a working state in the working time period according to the work command; the processing circuit controls the tracker to enter a sleep state according to the rest command.

According to yet another aspect of the present disclosure, a clustered tracking system includes a plurality of trackers and a cloud server. Each of the trackers includes a remote communication circuit, a positioning circuit and a processing circuit. The positioning circuit is configured to obtain a position information. The processing circuit is connected to the positioning circuit and the remote communication circuit, and operates in a default mode. The cloud server respectively receives a plurality of identity information and a plurality of the position information from a plurality of the remote communication circuits, and classifies the trackers being adjacent to each other into a tracked cluster according to the plurality of identity information and the plurality of the position information. The cloud server transmits a cluster command to the trackers in the tracked cluster, and the trackers in the tracked cluster are divided into a first tracker and at least one second tracker. The processing circuit of the first tracker controls the first tracker to enter a working state in a working time period according to the cluster command. The processing circuit of the at least one second tracker controls the at least one second tracker to enter a sleep state according to the cluster command.

According to still another aspect of the present disclosure, a clustered tracking method includes performing an information collecting step, an information receiving step and a tracker classifying step. The information collecting step includes configuring a plurality of processing circuits of a plurality of trackers to operate in a plurality of default modes. In each of the default modes, each of the processing circuits collects a position information from a positioning circuit of each of the trackers. The information receiving step includes configuring a cloud server to receive an identity information and the position information from a remote communication circuit of each of the trackers. The tracker classifying step includes configuring the cloud server to classify the trackers being adjacent to each other into a tracked cluster according to a plurality of the identity information and a plurality of the position information, and then transmit a cluster command to the trackers in the tracked cluster. The trackers in the tracked cluster are divided into a first tracker and at least one second tracker. The processing circuit of the first tracker controls the first tracker to enter a working state in a working time period according to the cluster command. The processing circuit of the at least one second tracker controls the at least one second tracker to enter a sleep state according to the cluster command.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a tracker connected to a cloud server according to a first embodiment of the present disclosure.

FIG. 2 shows a flow chart of a tracker tracking method according to a second embodiment of the present disclosure.

FIG. 3 shows a schematic view of a tracked cluster of the present disclosure.

FIG. 4 shows a schematic view of a clustered tracking system according to a third embodiment of the present disclosure.

FIG. 5 shows a flow chart of a clustered tracking method according to a fourth embodiment of the present disclosure.

FIG. 6 shows a flow chart of an information receiving step and an assigning step of the clustered tracking method of FIG. 5.

FIG. 7 shows a flow chart of an information exchanging step and an information comparing step of the clustered tracking method of FIG. 5.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected” to another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

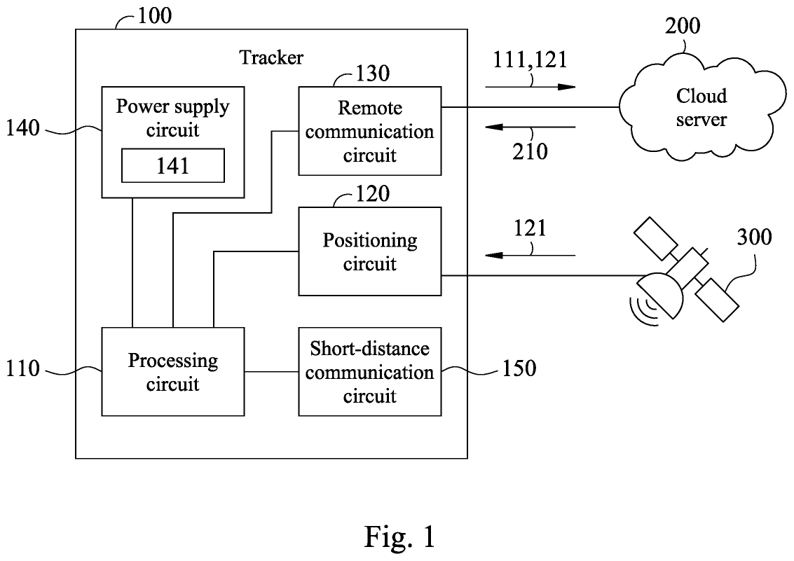

Please refer to FIG. 1. FIG. 1 shows a schematic view of a tracker 100 connected to a cloud server 200 according to a first embodiment of the present disclosure. In FIG. 1, the tracker 100 includes a processing circuit 110, a positioning circuit 120 and a remote communication circuit 130, and can be disposed on goods for the user to track the position of the goods.

The positioning circuit 120 can be a receiving circuit of Global Positioning System (GPS), and is signally connected to an artificial satellite 300 or a monitoring station (not shown) and configured to obtain a position information 121 of the tracker 100 from the artificial satellite 300 or the monitoring station, such as a GPS coordinate. The remote communication circuit 130 can be, but not limited to, a modem or other network communication modules, and is configured to be signally connected to the cloud server 200. The processing circuit 110 is electrically connected to the positioning circuit 120 and the remote communication circuit 130, and operates in a default mode. In the default mode, the processing circuit 110 controls the remote communication circuit 130 to transmit an identity information 111 and the position information 121 to the cloud server 200. Specifically, in the default mode, the processing circuit 110 wakes up each of the circuits of the tracker 100 every time interval, obtains the position information 121 of the tracker 100 through the positioning circuit 120 at the current time, and transmits the position information 121 with the identity information 111 to the cloud server 200 through the remote communication circuit 130. After the aforementioned operations are completed, the processing circuit 110 changes the tracker 100 from the default mode to a sleep mode. In the sleep mode, the processing circuit 110 drives the positioning circuit 120 and the remote communication circuit 130 into a sleep state to reduce power consumption, and wakes up each of the circuits of the tracker 100 until the next predetermined time. In other embodiments, the position information of the tracker can also be obtained through the remote communication circuit.

In response to determining that the cloud server 200 classifies the tracker 100 into a tracked cluster according to the position information 121, the remote communication circuit 130 receives a cluster command 210 from the cloud server 200, so that the processing circuit 110 is changed from the default mode to a cluster mode according to the cluster command 210. The cluster command 210 can include one of a work command and a rest command, and a working time period. In the cluster mode, if the cluster command 210 received by the processing circuit 110 includes the work command, the processing circuit 110 controls the tracker 100 to enter a working state in the working time period according to the work command; if the cluster command 210 received by the processing circuit 110 includes the rest command, the processing circuit 110 controls the tracker 100 to enter the sleep state according to the rest command.

Therefore, the tracker 100 of the present disclosure can be applied in goods tracking. For example, a truck is loaded with a lot of goods, and each of the goods can be assigned the tracker 100. Since a plurality of the trackers 100 are in the same truck, it represents that the trackers 100 are not too far away from each other (the distance between each other can be between 0-150 meters), and the trackers 100 are classified as the same tracked cluster. Therefore, the tracked cluster only needs one of the trackers 100 to enter the working state during the working time period, and report the position information 121 of the one of the trackers 100 to represent the positions of the rest of the trackers 100. At this time, the rest of the trackers 100 can enter the sleep state, and there is no need to wake up the positioning circuit 120 and the remote communication circuit 130 to report the position information 121 of the rest of the trackers 100 to the cloud server 200, thereby reducing the working time of the positioning circuit 120 and the remote communication circuit 130 of the rest of the trackers 100 so as to maximize the running time under the condition of limited power supply. A tracker tracking method of the present disclosure is described in more detail with the drawings below.

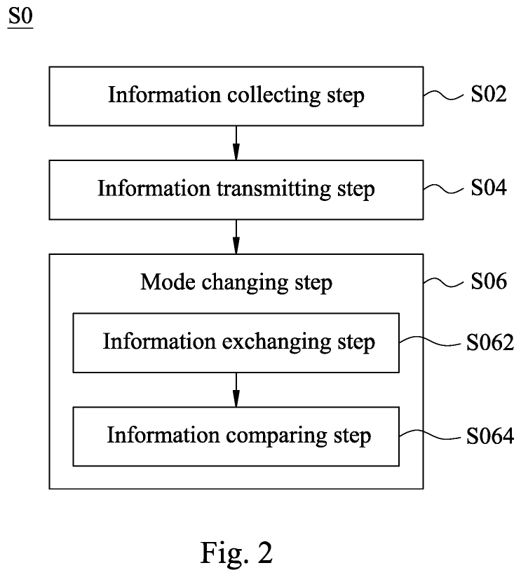

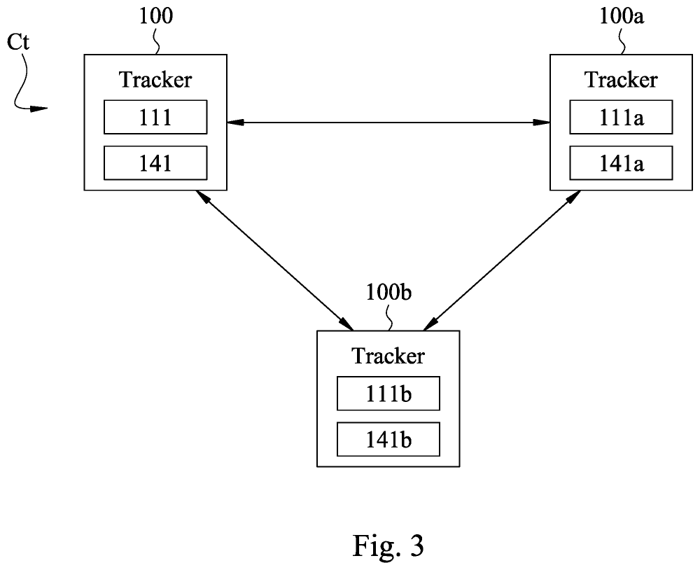

Please refer to FIGS. 1, 2 and 3. FIG. 2 shows a flow chart of a tracker tracking method S0 according to a second embodiment of the present disclosure. FIG. 3 shows a schematic view of a tracked cluster Ct of the present disclosure. In FIG. 2, the tracker tracking method S0 includes performing an information collecting step S02, an information transmitting step S04 and a mode changing step S06, and can be applied to the tracker 100 of the first embodiment. The following describes the operation of each of the steps in FIG. 2 in conjunction with the components shown in FIGS. 1 and 3.

The information collecting step S02 includes configuring the processing circuit 110 of the tracker 100 to operate in the default mode. In the default mode, the processing circuit 110 collects the position information 121 from the positioning circuit 120 of the tracker 100.

The information transmitting step S04 includes configuring the processing circuit 110 to control the remote communication circuit 130 of the tracker 100 to transmit the identity information 111 and the position information 121 to the cloud server 200. The identity information 111 can be, but not limited to, at least one of a Hardware Identification (HWID), a Media Access Control (MAC) address, a material number and a serial number. The HWID is an identifier string defined by the manufacturer according to different product devices. The MAC address is configured to provide the cloud server 200 to identify the address of the remote communication circuit 130.

The mode changing step S06 includes configuring the remote communication circuit 130 to receive a cluster command 210 from the cloud server 200, so that the processing circuit 110 is changed from the default mode to a cluster mode according to the cluster command 210. In mode changing step S06, the cloud server 200 connected to the remote communication circuit 130 determines that the tracker 100 is classified into the tracked cluster Ct according to the position information 121, and generates the cluster command 210.

The tracker 100 can further include a power supply circuit 140 and a short-distance communication circuit 150. The power supply circuit 140 can be a primary battery, or a secondary battery which can be rechargeable. The power supply circuit 140 is electrically connected to each of the circuits of the tracker 100 and configured to supply power. The power supply circuit 140 can include a battery management IC for providing a battery information 141, such as a battery capacity, a temperature and a State of Health (SOH) of a battery. In the information collecting step S02, the processing circuit 110 collects the battery information 141 from the power supply circuit 140. The short-distance communication circuit 150 can be, but not limited to, a Bluetooth-Low-Energy (BLE) module and is electrically connected to the processing circuit 110. In FIG. 3, the tracked cluster Ct can include the tracker 100 and a plurality of trackers 100a, 100b, which are adjacent to each other. The trackers 100, 100a, 100b are all products manufactured by the same manufacturer, so the trackers 100, 100a, 100b have the same internal circuit, but respectively have the identity information 111, 111a, 111b and the battery information 141, 141a, 141b, which are different to each other. The trackers 100, 100a, 100b all receive the cluster command 210 from the cloud server 200, and change from the default mode to the cluster mode according to the cluster command 210. The cluster command 210 can further include a rendezvous time period and the identity information 111, 111a, 111b. Each of the identity information 111, 111a, 111b is collected by the cloud server 200 when each of the tracker 100, 100a, 100b operates in the default mode, and is transmitted to each of the tracker 100, 100a, 100b through the cloud server 200.

The mode changing step S06 can further include performing an information exchanging step S062 and an information comparing step S064. The information exchanging step S062 configures the processing circuit 110 to wake up the short-distance communication circuit 150 in the rendezvous time period according to the cluster command 210, so that the short-distance communication circuit 150 of the tracker 100 exchanges information with two short-distance communication circuits of the trackers 100a, 100b. In detail, in the information exchanging step S062, the short-distance communication circuit 150 of the tracker 100 randomly operates in one of a peripheral mode and a central mode in the rendezvous time period, operates the peripheral mode at least once, and operates the central mode at least once. In the peripheral mode, the short-distance communication circuit 150 of the tracker 100 sends the identity information 111 and the battery information 141 to the two short-distance communication circuits of the trackers 100a, 100b; in the central mode, the short-distance communication circuit 150 of the tracker 100 receives the identity information 111a, 111b and the battery information 141a, 141b from the two short-distance communication circuits of the trackers 100a, 100b. The operations of the trackers 100a, 100b in the peripheral mode and the central mode are the same as the operation of the tracker 100, and not described again herein.

The information comparing step S064 configures the processing circuit 110 to compare its own the battery information 141 with the battery information 141a, 141b after the rendezvous time period. In response to determining that the battery information 141 is better than the battery information 141a, 141b, the processing circuit 110 controls the tracker 100 to enter the working state in the working time period; in response to determining that one of the battery information 141a, 141b is better than the battery information 141, the processing circuit 110 controls the tracker 100 to enter the sleep state.

For example, the battery information 141 records that the battery power of the tracker 100 is currently 90%, the battery information 141a records that the battery power of the tracker 100a is currently 80%, and the battery information 141b records that the battery power of the tracker 100b is currently 70%. After the current rendezvous time period, since the battery information 141 of the tracker 100 has the maximum battery power, the battery information 141 of the tracker 100 is the best among the battery information 141, 141a, 141b (i.e., the battery information 141 is better than the battery information 141a, 141b), so the tracker 100 will enter the working state, and the trackers 100a, 100b will enter the sleep state. In other embodiments, the battery information can be a battery life, a battery temperature or a SOH of a battery. The maximum remaining life, the lowest temperature or the highest SOH of the battery all represent the best battery information, or selecting a plurality of battery information from the above-mentioned battery information to generate a comprehensive battery information generated after weight calculation, and then comparing the comprehensive battery information of each of the trackers to select the tracker with the best battery information.

In the cluster mode, the processing circuit 110 of the tracker 100 in the working state wakes up the positioning circuit 120 and the remote communication circuit 130 of the tracker 100 during the working time period, and obtains the position information 121 of the tracker 100 through the positioning circuit 120 and transmits the position information 121 to the cloud server 200 through the remote communication circuit 130. During the non-working time period, the processing circuit 110 still drives the positioning circuit 120, the remote communication circuit 130 and the short-distance communication circuit 150 to enter the sleep state. In addition, the processing circuits of the trackers 100a, 100b in the sleep state drive the positioning circuits and the remote communication circuits to enter the sleep state to reduce power consumption, and wake up the positioning circuits and the remote communication circuits again until the next rendezvous time period. In the next rendezvous time period, the tracked cluster Ct repeats the information exchanging step S062 and the information comparing step S064 to select the tracker with the best battery information as the worker, and drive the rest of trackers to sleep. Moreover, in the information exchanging step S062, in response to determining that the short-distance communication circuit 150 does not receive the identity information 111a, 111b and the battery information 141a, 141b from the tracker 100a, 100b after each of the rendezvous time periods, the processing circuit 110 is changed from the cluster mode to the default mode until receiving another cluster command 210 from the cloud server 200 again.

Therefore, the tracker tracking method S0 of the present disclosure achieves the purpose of power saving through the method of assigning the tracker with the best battery information as a represent in turn, that is, a representative device of the tracked cluster Ct sends information to the cloud server 200 instead the other non-representative devices of the tracked cluster Ct, and the other non-representative devices can continue to enter the sleep state.

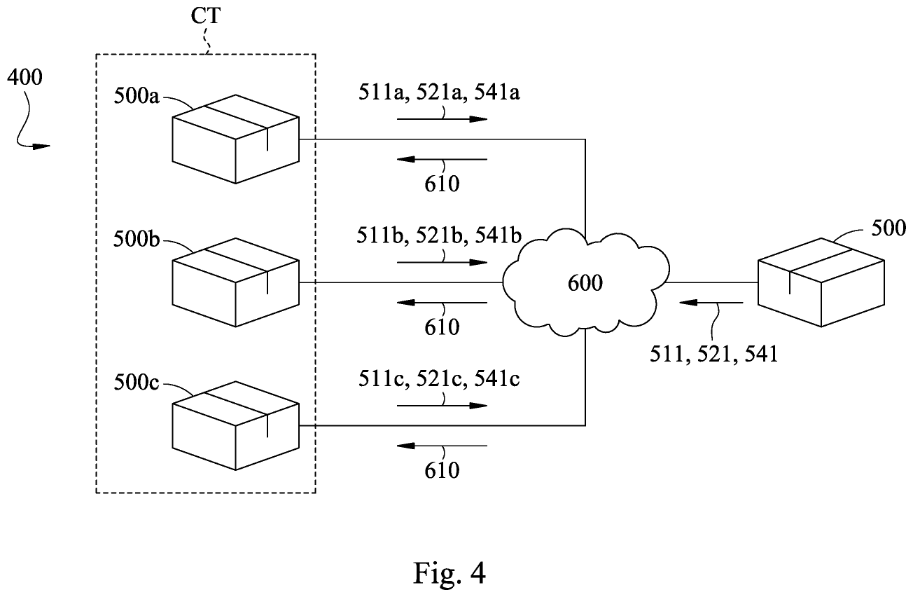

Please refer to FIGS. 1 and 4. FIG. 4 shows a schematic view of a clustered tracking system 400 according to a third embodiment of the present disclosure. In FIG. 4, the clustered tracking system 400 includes a plurality of trackers 500, 500a, 500b, 500c and a cloud server 600. Each of the trackers 500, 500a, 500b, 500c includes a processing circuit, a positioning circuit, a remote communication circuit, a power supply circuit and a short-distance communication circuit, and the aforementioned circuits are respectively the same as the processing circuit 110, the positioning circuit 120, the remote communication circuit 130, the power supply circuit 140 and the short-distance communication circuit 150 of the tracker 100 of the first embodiment, so the structural configurations of the aforementioned circuits are not described again herein.

Each of the tracker 500, 500a, 500b, 500c operates in a default mode after being turned on, and is signally connected to the cloud server 600 through its own remote communication circuit. The cloud server 600 can include a Central Processing Unit (CPU) and a database. The cloud server 600 uses CPU or Computing in Memory (CIM) for data processing, and stores the information of each of the tracker 500, 500a, 500b, 500c through the database. The cloud server 600 receives a plurality of identity information 511, 511a, 511b, 511c and a plurality of position information 521, 521a, 521b, 521c from the remote communication circuits of the trackers 500, 500a, 500b, 500c, respectively. The cloud server 600 classifies the trackers 500a, 500b, 500c being adjacent to each other into a tracked cluster CT according to the identity information 511a, 511b, 511c and the position information 521a, 521b, 521c, and classifies the tracker 500 into an independent device according to the identity information 511 and the position information 521. Specifically, the cloud server 600 determines that the trackers 500a, 500b, 500c are adjacent to each other according to the GPS coordinates of the position information 521a, 521b, 521c, and determines that there is no other tracker around the tracker 500. When the tracker 500 is classified into the independent device, the tracker 500 continues to be in the default mode.

The trackers 500a, 500b, 500c in the tracked cluster CT can be divided into a first tracker and two second trackers, and the battery information of the first tracker is better than the battery information of the second trackers. In detail, the cloud server 600 can receive a plurality of battery information 541a, 541b, 541c from the remote communication circuits of the trackers 500a, 500b, 500c, respectively. The cloud server 600 assigns the tracker with the best battery information in the tracked cluster CT as the first tracker, and assigns a rest of the trackers in the tracked cluster as the second trackers. For example, the battery information 541a records that the battery power of the tracker 500a is currently 90%, the battery information 541b records that the battery power of the tracker 500b is currently 80%, and the battery information 541c records that the battery power of the tracker 500c is currently 70%. Therefore, the cloud server 600 assigns the tracker 500a as the first tracker and assigns the rest of the trackers 500b, 500c as the second trackers in the tracked cluster CT, and then transmits a cluster command 610 to the trackers 500a, 500b, 500c in the tracked cluster CT.

In addition, the cluster command 610 can include an operation lookup table, which includes a tracker information field and an operation status field, as listed in Table 1 below. Table 1 lists the operation lookup table of the present disclosure, and lists the corresponding operation states of different tracker information.

TABLE 1

| Tracker information field | operation status |
|---|---|
| identity information 511 | Work |
| identity information 511a | Sleep |
| identity information 511b | Sleep |
| identity information 511c | Sleep |

The processing circuit of the tracker 500a assigned as the first tracker controls the tracker 500a to enter a working state in a working time period according to the operation lookup table of the cluster command 610. The processing circuits of the tracker 500b, 500c assigned as the second trackers respectively control the tracker 500b, 500c to enter a sleep state according to the operation lookup table of the cluster command 610. An operation flow of a clustered tracking method of the present disclosure is described in more detail with the drawings below.

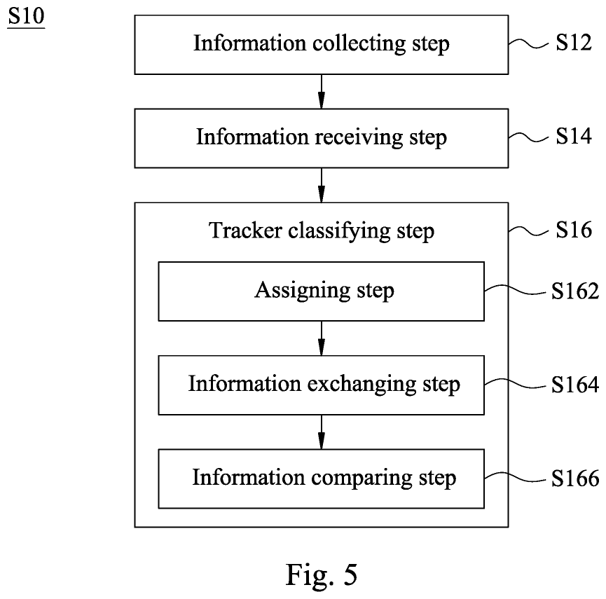

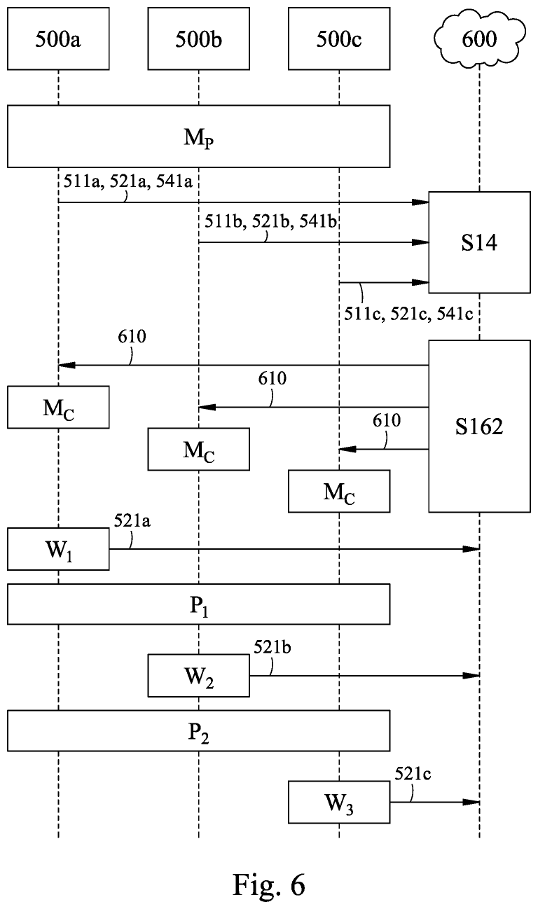

Please refer to FIGS. 4, 5 and 6. FIG. 5 shows a flow chart of a clustered tracking method S10 according to a fourth embodiment of the present disclosure. FIG. 6 shows a flow chart of an information receiving step S14 and an assigning step S162 of the clustered tracking method S10 of FIG. 5. In FIG. 5, the clustered tracking method S10 includes performing an information collecting step S12, an information receiving step S14 and a tracker classifying step S16, and can be applied to the clustered tracking system 400 of the third embodiment. The following describes the operation of each of the steps in FIG. 5 in conjunction with the components shown in FIGS. 4 and 6, and FIG. 6 only shows the corresponding relationship between the tracked cluster CT and the cloud server 600 on the timeline.

The information collecting step S12 includes configuring the processing circuits of the trackers 500, 500a, 500b, 500c to operate in the default modes (the default modes are a default mode M_{P} in FIG. 6). In the default mode M_{P}, the processing circuits of the trackers 500, 500a, 500b, 500c collect the position information 521, 521a, 521b, 521c from the positioning circuits, and collect the battery information 541, 541a, 541b, 541c from the power supply circuits, respectively.

The information receiving step S14 includes configuring the cloud server 600 to receive the identity information 511, 511a, 511b, 511c, the position information 521, 521a, 521b, 521c and the battery information 541, 541a, 541b, 541c from the remote communication circuits of the trackers 500, 500a, 500b, 500c, respectively.

The tracker classifying step S16 includes configuring the cloud server 600 to classify the trackers 500a, 500b, 500c being adjacent to each other into the tracked cluster CT according to the identity information 511a, 511b, 511c and the position information 521a, 521b, 521c, classify the tracker 500 into the independent device according to the identity information 511 and the position information 521, and then transmit the cluster command 610 to the trackers 500a, 500b, 500c in the tracked cluster CT. In the tracker classifying step S16, the processing circuit of each of the trackers 500a, 500b, 500c is changed from the default mode M_{P} to a cluster mode M_{C} according to the cluster command 610.

The tracker classifying step S16 can further include performing an assigning step S162. The assigning step S162 configures the cloud server 600 to assign the tracker 500a in the tracked cluster CT as the first tracker, and assign the rest of the trackers 500b, 500c in the tracked cluster CT as the second trackers. The battery information 541a of the tracker 500a assigned as the first tracker is better than the battery information 541b, 541c of the trackers 500b, 500c assigned as the second trackers.

Further, the cluster command 610 can include a plurality of working time periods W₁, W₂, W₃. The working time period W₁ is the first working time period, the working time period W₂ is the second working time period, the working time period W₃ is the third working time period, and the present disclosure is not limited by the number of the working time periods. In the cluster mode M_{C}, the processing circuit of the tracker 500a assigned as the first tracker controls the tracker 500a to enter the working state in the working time period W₁ according to the operation lookup table of the cluster command 610, and transmits the position information 521a to the cloud server 600. The processing circuits of the trackers 500b, 500c assigned as the second trackers control the trackers 500b, 500c to enter the sleep state according to the operation lookup table of the cluster command 610, so that the trackers 500b, 500c can achieve power saving.

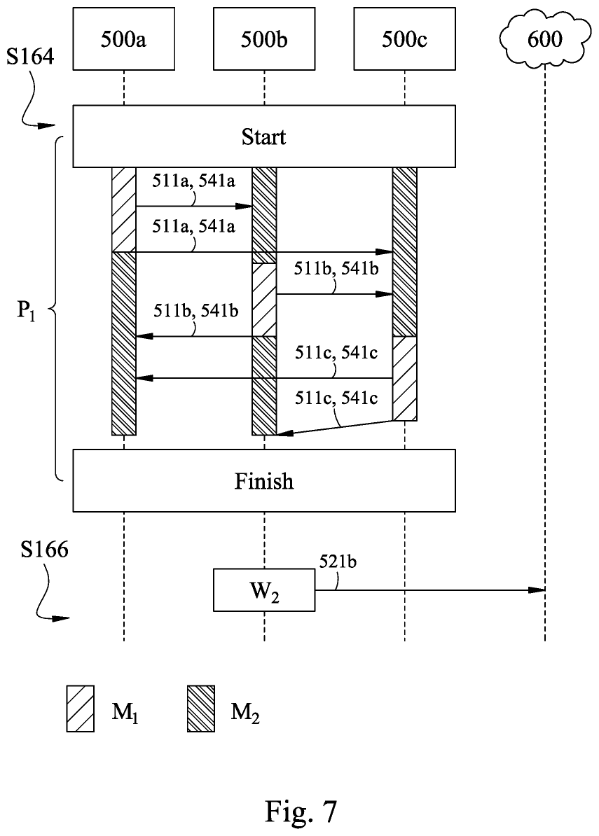

Please refer to FIGS. 4 to 6 and 7. FIG. 7 shows a flow chart of an information exchanging step S164 and an information comparing step S166 of the clustered tracking method S10 of FIG. 5. The cluster command 610 can further include a plurality of rendezvous time periods P₁, P₂ and the identity information 511a, 511b, 511c. The rendezvous time period P₁ is the first rendezvous time period, the rendezvous time period P₂ is the second rendezvous time period, and the present disclosure is not limited by the number of the rendezvous time periods. The tracker classifying step S16 can further include performing an information exchanging step S164. The information exchanging step S164 configures the processing circuit of each of the trackers 500a, 500b, 500c in the tracked cluster CT to wake up the short-distance communication circuit in the rendezvous time period P₁ according to the cluster command 610, so that the short-distance communication circuit of each of the trackers 500a, 500b, 500c in the tracked cluster CT to exchange information in the rendezvous time period P₁. In FIG. 7, in the information exchanging step S164, the short-distance communication circuit of each of the trackers 500a, 500b, 500c randomly operates in one of a peripheral mode M₁ and a central mode M₂ in the rendezvous time period P₁, and operates the peripheral mode M₁ at least once, and operates the central mode M₂ at least once. The operation of the tracker 500a is described in more detail below, and the trackers 500b, 500c are not described again herein.

The short-distance communication circuit of the tracker 500a randomly switches between the peripheral mode M₁ and the central mode M₂ in the rendezvous time period P₁. In the peripheral mode M₁, the short-distance communication circuit sends the identity information 511a and the battery information 541a to the trackers 500b, 500c; in the central mode M₂, the short-distance communication circuit receives the identity information 511b, 511c and the battery information 541b, 541c from the trackers 500b, 500c. In other words, each of the short-distance communication circuits in the tracked cluster CT operates in the central mode M₂ for a certain period of time of the rendezvous time period P₁ and receives the broadcast packets transmitted by the surrounding devices, and operates in the peripheral mode M₁ for another certain period of time and transmits its own broadcast packet to the surrounding devices. Thus, the clustered tracking method S10 of the present disclosure can avoid the problem of missing information caused when the trackers 500a, 500b, 500c in the tracked cluster CT are all in the central mode M₂, and can also avoid the problem that the information the surrounding devices cannot be collected when the trackers 500a, 500b, 500c in the tracked cluster CT are all in the peripheral mode M₁.

The tracker classifying step S16 can further include performing an information comparing step S166. The information comparing step S166 configures the processing circuit of each of the trackers 500a, 500b, 500c in the tracked cluster CT to compare the battery information 541a, 541b, 541c after the rendezvous time period P₁. For example, after the rendezvous time period P₁, the battery information 541a records that the battery power of the tracker 500a is currently 60%, the battery information 541b records that the battery power of the tracker 500b is currently 75%, and the battery information 541c records that the battery power of the tracker 500c is currently 65%. The battery information 541b of the tracker 500b in the tracked cluster CT is better than the battery information 541a, 541c received from the short-distance communication circuits of the rest of the trackers 500a, 500c. The processing circuit of the tracker 500b controls the tracker 500b to enter the working state in the working time period W₂, and transmits the position information 521b to the cloud server 600. On the contrary, both of the battery information 541a, 541c of the trackers 500a, 500c are not better than the battery information 541b received from the short-distance communication circuit of the tracker 500b. The processing circuits of the trackers 500a, 500c respectively control the trackers 500a, 500c to enter the sleep state. It is obvious that, if the battery information 541c of the tracker 500c is better than the battery information 541a, 541b of the trackers 500a, 500b after the rendezvous time period P₂, the processing circuit of the tracker 500c controls the tracker 500c to enter the working state in the working time period W₃ and transmits the position information 521c to the cloud server 600.

In information exchanging step S164, in response to determining that the short-distance communication circuit of each of the trackers 500a, 500b, 500c does not receive the identity information 511a, 511b, 511c of the cluster command 610 from the short-distance communication circuits of the rest of the trackers in the tracked cluster CT after each of rendezvous time periods P₁, P₂, the processing circuit of each of the trackers 500a, 500b, 500c in the tracked cluster CT is changed from the cluster mode M_{C} to the default mode M_{P} until receiving another cluster command 610 from the cloud server 600 again.

According to the aforementioned embodiments and examples, the advantages of the present disclosure are described as follows.
1. Maximizing the running time of the tracker effectively.
2. When the tracker uses a battery with the general capacity, the tracker can not only run for a long time, but also keep the tracker small.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A tracker, comprising:
a positioning circuit configured to obtain a position information;
a remote communication circuit configured to be signally connected to a cloud server; and
a processing circuit connected to the positioning circuit and the remote communication circuit and operating in a default mode, wherein in the default mode, the processing circuit controls the remote communication circuit to transmit an identity information and the position information to the cloud server;
wherein the remote communication circuit receives a cluster command from the cloud server, so that the processing circuit is changed from the default mode to a cluster mode according to the cluster command, and the cluster command comprises one of a work command and a rest command, and a working time period;
wherein in the cluster mode, the processing circuit controls the tracker to enter a working state in the working time period according to the work command; the processing circuit controls the tracker to enter a sleep state according to the rest command.

2. The tracker of claim 1, wherein the tracker is classified into a tracked cluster, the tracked cluster comprises the tracker and another tracker, the cluster command further comprises a rendezvous time period, and the tracker further comprises:
a short-distance communication circuit connected to the processing circuit;
wherein in the cluster mode, the processing circuit wakes up the short-distance communication circuit in the rendezvous time period according to the cluster command, so that the short-distance communication circuit exchanges information with the another tracker.

3. The tracker of claim 2, further comprising:
a power supply circuit connected to the processing circuit and configured to provide a battery information;
wherein the short-distance communication circuit randomly operates in one of a peripheral mode and a central mode in the rendezvous time period, in the peripheral mode, the short-distance communication circuit sends the identity information and the battery information to the another tracker, and in the central mode, the short-distance communication circuit receives another identity information and another battery information from the another tracker.

4. The tracker of claim 3, wherein the processing circuit compares the battery information with the another battery information after the rendezvous time period, wherein,
in response to determining that the battery information is better than the another battery information, the processing circuit controls the tracker to enter the working state in the working time period; and
in response to determining that the another battery information is better than the battery information, the processing circuit controls the tracker to enter the sleep state.

5. The tracker of claim 2, wherein the cluster command further comprises another identity information of the another tracker, and in response to determining that the short-distance communication circuit does not receive the another identity information from the another tracker after the rendezvous time period, the processing circuit is changed from the cluster mode to the default mode.

6. A tracker tracking method, comprising:
performing an information collecting step comprising configuring a processing circuit of a tracker to operate in a default mode, wherein in the default mode, the processing circuit collects a position information from a positioning circuit of the tracker;
performing an information transmitting step comprising configuring the processing circuit to control a remote communication circuit of the tracker to transmit an identity information and the position information to a cloud server; and
performing a mode changing step comprising configuring the remote communication circuit to receive a cluster command from the cloud server, so that the processing circuit is changed from the default mode to a cluster mode according to the cluster command, and the cluster command comprises one of a work command and a rest command, and a working time period;
wherein in the cluster mode, the processing circuit controls the tracker to enter a working state in the working time period according to the work command; the processing circuit controls the tracker to enter a sleep state according to the rest command.

7. The tracker tracking method of claim 6, wherein the tracker is classified into a tracked cluster, the tracked cluster comprises the tracker and another tracker, the cluster command further comprises a rendezvous time period, and the mode changing step further comprises:
performing an information exchanging step to configure the processing circuit to wake up a short-distance communication circuit in the rendezvous time period according to the cluster command, so that the short-distance communication circuit exchanges information with the another tracker.

8. The tracker tracking method of claim 7, wherein the track comprises a power supply circuit, which is configured to provide a battery information, in the information exchanging step, the short-distance communication circuit randomly operates in one of a peripheral mode and a central mode in the rendezvous time period, in the peripheral mode, the short-distance communication circuit sends the identity information and the battery information to the another tracker, and in the central mode, the short-distance communication circuit receives another identity information and another battery information from the another tracker.

9. The tracker tracking method of claim 8, wherein the mode changing step further comprises:
performing an information comparing step to configure the processing circuit to compare the battery information with the another battery information after the rendezvous time period;
wherein in response to determining that the battery information is better than the another battery information, the processing circuit controls the tracker to enter the working state in the working time period;
wherein in response to determining that the another battery information is better than the battery information, the processing circuit controls the tracker to enter the sleep state.

10. The tracker tracking method of claim 7, wherein the cluster command further comprises another identity information of the another tracker, and in the information exchanging step, in response to determining that the short-distance communication circuit does not receive the another identity information from the another tracker after the rendezvous time period, the processing circuit is changed from the cluster mode to the default mode.

11. A clustered tracking system, comprising:
a plurality of trackers, wherein each of the trackers comprises:
a remote communication circuit;
a positioning circuit configured to obtain a position information; and
a processing circuit connected to the positioning circuit and the remote communication circuit and operating in a default mode; and
a cloud server respectively receiving a plurality of identity information and a plurality of the position information from a plurality of the remote communication circuits and classifying the trackers being adjacent to each other into a tracked cluster according to the plurality of identity information and the plurality of the position information, wherein the cloud server transmits a cluster command to the trackers in the tracked cluster, and the trackers in the tracked cluster are divided into a first tracker and at least one second tracker;
wherein the processing circuit of the first tracker controls the first tracker to enter a working state in a working time period according to the cluster command;
wherein the processing circuit of the at least one second tracker controls the at least one second tracker to enter a sleep state according to the cluster command.

12. The clustered tracking system of claim 11, wherein a number of the at least one second tracker is plural, and each of the trackers further comprises a power supply circuit, which is connected to the processing circuit and configured to provide a battery information, the cloud server respectively receives a plurality of the battery information from the plurality of the remote communication circuits of the trackers, the cloud server assigns one of the trackers in the tracked cluster as the first tracker and assigns a rest of the trackers in the tracked cluster as the second trackers, and the battery information of the first tracker is better than the plurality of the battery information of the second trackers.

13. A clustered tracking method, comprising:
performing an information collecting step comprising configuring a plurality of processing circuits of a plurality of trackers to operate in a plurality of default modes, wherein in each of the default modes, each of the processing circuits collects a position information from a positioning circuit of each of the trackers;
performing an information receiving step comprising configuring a cloud server to receive an identity information and the position information from a remote communication circuit of each of the trackers; and
performing a tracker classifying step comprising configuring the cloud server to classify the trackers being adjacent to each other into a tracked cluster according to a plurality of the identity information and a plurality of the position information, and then transmit a cluster command to the trackers in the tracked cluster, wherein the trackers in the tracked cluster are divided into a first tracker and at least one second tracker;
wherein the processing circuit of the first tracker controls the first tracker to enter a working state in a working time period according to the cluster command;
wherein the processing circuit of the at least one second tracker controls the at least one second tracker to enter a sleep state according to the cluster command.

14. The clustered tracking method of claim 13, wherein each of the trackers comprises a power supply circuit, which is configured to provide a battery information, each of the processing circuits collects the battery information from the power supply circuit, and the information receiving step further comprises:
configuring the cloud server to respectively receive a plurality of the battery information from a plurality of the remote communication circuits of the trackers.

15. The clustered tracking method of claim 14, wherein a number of the at least one second tracker is plural, and the tracker classifying step further comprises:
performing an assigning step to configure the cloud server to assign one of the trackers in the tracked cluster as the first tracker and assign a rest of the trackers in the tracked cluster as the second trackers, wherein the battery information of the first tracker is better than the plurality of the battery information of the second trackers.

16. The clustered tracking method of claim 14, wherein the cluster command comprises a rendezvous time period, and the tracker classifying step further comprises:
performing an information exchanging step to configure a short-distance communication circuit of each of the trackers in the tracked cluster to exchange information in the rendezvous time period.

17. The clustered tracking method of claim 16, wherein in the information exchanging step, the short-distance communication circuit of each of the trackers randomly operates in one of a peripheral mode and a central mode in the rendezvous time period, in the peripheral mode, the short-distance communication circuit of each of the trackers sends the identity information and the battery information to a rest of the short-distance communication circuits in the tracked cluster, and in the central mode, the short-distance communication circuit of each of the trackers receives the plurality of the identity information and the plurality of the battery information from the rest of the short-distance communication circuits in the tracked cluster.

18. The clustered tracking method of claim 17, wherein the tracker classifying step further comprises:
performing an information comparing step to configure the processing circuit of each of the trackers in the tracked cluster to compare the battery information with the plurality of the battery information received from the rest of the short-distance communication circuits after the rendezvous time period;
wherein in response to determining that the battery information of one of the trackers in the tracked cluster is better than the plurality of the battery information received from the rest of the short-distance communication circuits, the processing circuit of the one of the trackers controls the one of the trackers to enter the working state in the working time period;
wherein in response to determining that the battery information of another one of the trackers in the tracked cluster is not better than one of the plurality of the battery information received from the rest of the short-distance communication circuits, the processing circuit of the another one of the trackers controls the another one of the trackers to enter the sleep state.

19. The clustered tracking method of claim 16, wherein in the tracker classifying step, each of the trackers in the tracked cluster is changed from each of the default modes to a cluster mode according to the cluster command, the cluster command further comprises the plurality of the identity information of the trackers in the tracked cluster, and in the information exchanging step, in response to determining that the short-distance communication circuit of each of the trackers does not receive one of the plurality of the identity information from a rest of the short-distance communication circuits in the tracked cluster after the rendezvous time period, the processing circuit of each of the trackers in the tracked cluster is changed from the cluster mode to the default mode.
